(19) United States
(12) Patent Application Publication
(10) Pub. No.: US 2018/0362098 A1
(43) Pub. Date: Dec. 20, 2018

(54) SELF-PROPELLED MULTIPURPOSE VEHICLE

(71) Applicant: STAAL INDUSTRIES IVS, Copenhagen K (DK)

(72) Inventor: Martin STAAL, Grevinge (DK)

(73) Assignee: STAAL INDUSTRIES IVS, Copenhagen K (DK)

(21) Appl. No.: 16/062,449

(22) PCT Filed: Dec. 8, 2016
(86) PCT No.: PCT/DK2016/050419

§ 371 Date: Jun. 14, 2018

(30) Foreign Application Priority Data
Dec. 15, 2015 (DK) PA 2015 00806

(51) Int. Cl. B62D 33/063; B62D 21/18; B62D 49/06

(52) U.S. Cl. CPC B62D 33/0633; B62D 49/065; B62D 21/186

(57) ABSTRACT

A self-propelled multipurpose vehicle with a chassis including an engine driving one or more hydraulic pumps, and a platform with a driver seat and one or more controls for a driver. The platform is rotatably mounted to the chassis, and the platform is provided with hydraulic power from at least one of said one or more hydraulic pumps. The vehicle may hold a workstation for carrying a tool, with the workstation being connected to the chassis at a position next to the rotatable platform, and with the workstation being provided with hydraulic power from the hydraulic pump(s). The vehicle may also hold a working boom for carrying a tool, where the working boom is supported by the rotatable platform and powered by hydraulic power from the hydraulic pump(s).

### TECHNICAL FIELD

The present disclosure relates to a self-propelled multipurpose vehicle for performing a variety of tasks, which may include construction, landscaping, agricultural and industrial tasks.

### BACKGROUND

U.S. Pat. No. 6,409,457 discloses a multipurpose work vehicle, which includes a chassis, a cabin mounted on a first side of the chassis on a forward portion thereof, and a plurality of wheels coupled to the chassis to movably support the chassis. The vehicle also includes a boom unit, a tool coupled to an end of the boom unit, and turntable unit mounted to the chassis at a central portion thereof, the turntable unit coupled to and supporting the boom unit for rotation relative to the chassis. The vehicle further includes a dump body mounted to a rear portion of the chassis. The turntable unit is capable of moving the boom unit and the tool over a second side of the chassis opposite the first side between a first position at which the tool is positioned forward of the chassis to pick up the load and a second position at which the tool is positioned over the dump body to dump the load into the dump body. The dump body can be tilted to the rear or either side of the vehicle. The tool attached to the boom unit can be a dipper bucket, a loader bucket, a mower, thresher or auger, for example. An accessory tool such as a mower can also be attached to the rear of the vehicle.

For the work vehicle disclosed in U.S. Pat. No. 6,409,457, the boom unit and the cabin are separated from each other, with the boom unit being coupled to the turntable, whereby the boom unit with tool can be rotated between the first and second positions, while the cabin is fixedly mounted on the chassis. Thus, an operator seated in the cabin will have difficulty in facing the tool when the tool is positioned to dump a load in the dump body, which is arranged behind the cabin with the operator. A solution to this problem is suggested in U.S. Pat. No. 6,409,457 by having a co-operator seated in the cabin behind the operator, whereby the co-operator can view the boom unit and tool when discharging a load into the dump body. Such a solution is only suitable for large work vehicle, and is also expensive in labor force.

Another solution for a combined digger-dumper work vehicle is presented by the so called Dumphoe machine. The Dumphoe machine has a chassis, a platform rotatably mounted on a forward portion of the chassis, a dump body mounted to a rear portion of the chassis, and a plurality of wheels coupled to the chassis to movably support the chassis. The platform holds a cabin for a driver and a boom unit with an excavator bucket, and the platform can be moved between a first position at which the excavator bucket is positioned forward of the chassis to pick up a load and a second position at which the excavator bucket is positioned over the dump body to dump the load into the dump body. By having the cabin arranged at the rotatable platform, the cabin will rotate together with the platform when the platform is moving the boom unit with the excavator bucket, whereby the driver is able to face the excavator bucket both when the bucket is picking up a load and when the bucket is dumping the load into the dump body. The engine and hydraulic pumps for driving the boom unit is arranged at the rotatable platform, whereby a counterbalance for the boom unit and excavator bucket is obtained. The solution provided by the Damphoe machine needs a lot of space for the platform and the parts mounted to the platform, whereby the Damphoe solution is best suited for larger work vehicles, and not well suited for compact work vehicles.

It would be desirable to provide a multipurpose work vehicle, for which the operator can be brought into different positions to control both the charge of a load into the tool and the discharge of the load into a dump body, allowing the vehicle to be operated by a single person, which work vehicle would also be suitable as a compact work vehicle.

### SUMMARY

It is an object to provide a multipurpose work vehicle, which provides an improved solution to the problem of controlling the charging and discharging of a load.

It is also an object to provide a multipurpose work vehicle, which provides an improved solution for a compact work vehicle.

Accordingly there is provided a self-propelled vehicle or multipurpose vehicle comprising: a chassis including an engine driving one or more hydraulic pumps, and a rotatable platform with a driver seat and one or more controls for a driver, wherein the rotatable platform is rotatably supported by the chassis, and wherein the platform is provided with hydraulic power from at least one of said one or more hydraulic pumps.

The vehicle may comprise a workstation for carrying a tool, where the workstation is connected to the chassis at a position next to the rotatable platform, and where the workstation is provided with hydraulic power from the hydraulic pump(s).

The chassis may have an at least partly horizontal extending upper surface for supporting the platform and the workstation next to one another. The rotatable platform may be mounted to the chassis for rotating about a rotational axis normal to a horizontal extending upper surface part of the chassis.

It is preferred that the workstation for carrying a tool is a multipurpose workstation for carrying a tool selected from a plurality of different tools.

It is within embodiments of the disclosure that the vehicle comprises a working boom for carrying a tool, where the working boom is supported by the rotatable platform and powered by hydraulic power from the hydraulic pump(s). It is preferred that the working boom for carrying a tool is a multipurpose boom for carrying a tool selected from a plurality of different tools. It is also within embodiments of the disclosure that the vehicle comprises hydraulic couplings arranged at the front and/or the back end of the chassis for carrying a tool, where the front and/or back couplings are provided with hydraulic power from the hydraulic pump(s).

By having a vehicle with a platform, which supports a working boom and holds a driver seat and driver controls, and which is rotatably mounted to a chassis of the vehicle, the driver or operator of the vehicle can be brought into different positions to control both the charge of a load into the tool carried by the working boom and the discharge of the load into a dump body carried by the workstation of the chassis. This allows the vehicle to be operated by a single person. Arranging the hydraulic pumps and the engine driving the pumps in the chassis of the vehicle makes it suitable for a compact work vehicle.

It is preferred that the vehicle of the disclosure comprises a number of hydraulic valve control arrangements for controlling hydraulic power from the hydraulic pump(s) to hydraulic power consumers, such as hydraulic actuators and hydraulic motors for operating the tools coupled to the vehicle and for operating driving of the vehicle. Thus, the vehicle may comprise a first valve control arrangement in the chassis for controlling hydraulic power from the hydraulic pump(s) to hydraulic power consumers connected to the chassis. At least part of the hydraulic power consumers controlled by the first valve arrangement may be directly coupled to the chassis. The hydraulic power for powering the workstation may be controlled via the first valve arrangement in the chassis, and also the hydraulic power for powering the front and/or back couplers may be controlled via the first valve arrangement in the chassis. The vehicle of the disclosure may comprise a second valve arrangement in the rotatable platform for controlling hydraulic power from the hydraulic pump(s) to hydraulic power consumers connected to the rotatable platform. At least part of the hydraulic power consumers controlled by the second valve arrangement may be directly coupled to the platform. The hydraulic power for powering the working boom may be controlled via the second valve arrangement in the rotatable platform.

It is preferred that the chassis of the vehicle includes at least a first and a second hydraulic pump, which pumps are driven by the engine, where the first hydraulic pump is arranged for providing hydraulic power to at least part of the valves of the first valve arrangement, and where the second hydraulic pump is arranged for providing hydraulic power to at least part of the valves of the second valve arrangement. The first hydraulic pump may further be arranged for providing hydraulic power to at least part of the valves of the second valve arrangement, and the second hydraulic pump may further be arranged for providing hydraulic power to at least part of the valves of the first valve arrangement. It is preferred that first pump is arranged for being selectable coupled to the second valve arrangement and/or that the second pump is arranged for being selectable coupled to the first valve arrangement. The chassis may further hold or include at least one hydraulic fluid reservoir for supplying hydraulic fluid to the hydraulic pump(s) and for receiving a return of hydraulic fluid from the valve arrangements.

When having the first pump being selectable coupled for providing hydraulic power to the second vale system in the platform, and the second pump is selectable coupled for providing hydraulic power to the to the first valve arrangement in the chassis, both pumps can be selected for delivering hydraulic power to the hydraulic consumers at the platform, when there is only a minor need for hydraulic power at the chassis, and both pumps can be selected for providing hydraulic power to hydraulic consumers at the chassis, when there is only a minor need for hydraulic power at the platform.

It is within embodiments of the disclosure that the vehicle comprises a swivel or swivel joint between the chassis and the rotatable platform, where the swivel is configured for allowing hydraulic supply and return conduits to connect between the chassis and the rotatable platform. The swivel may further be configured for allowing electric signal cables and/or electric power cables to connect between the chassis and the rotatable platform. The swivel may be configured for providing a hydraulic supply connection between a supply conduit in the chassis from the second pump and a supply conduit in the platform to the second valve arrangement, and configured for providing a hydraulic return connection between a return conduit in the platform from the second valve arrangement and a return conduit in the chassis to the hydraulic fluid reservoir. The swivel may further be configured for providing a hydraulic supply connection between a supply conduit in the chassis from the first pump and a supply conduit in the platform to the second valve arrangement.

By having the hydraulic fluid connections from the chassis to the platform being provided by the swivel, the platform can rotate relative to the chassis without twisting any hydraulic conduits, allowing a high degree of rotation or even a free rotation of the platform relative to the chassis.

It is preferred that the rotatable platform is mounted to the chassis for rotating between a first position and a second position about a rotational axis normal to an upper surface of the chassis, where the rotatable platform is rotated a half circle or 180° when rotated from the first to the second position. The platform may be mounted for rotating between the first and second positions in both a clockwise and an anti-clockwise direction about the rotational axis. The platform may also be mounted for being rotating a full circle of 360° in both a clockwise and an anti-clockwise direction about the rotational axis. The rotation of the platform may be powered by hydraulic power from the hydraulic pump(s). According to an embodiment the hydraulic power for powering the rotation of the platform is controlled via the second valve arrangement in the rotatable platform, but it is also within an embodiment that the hydraulic power for powering the rotation of the platform is controlled via the first valve arrangement in the chassis.

It is preferred that the chassis of the vehicle is further provided with a plurality of linear hydraulic actuators powered by hydraulic fluid from the first or second or a third pump in said chassis via a valve arrangement in said chassis.

In order to move the vehicle of the disclosure, the chassis may be provided with four hydraulically driven and hydraulically steerable wheels. Each of the wheels may be provided with a hydraulic wheel motor that is supplied with hydraulic fluid from the first or second or a third pump in the chassis via a valve arrangement in said chassis. Hydraulic power for steering the wheels may be provided by the first or second or a third pump in the chassis via a valve arrangement in said chassis. It is preferred that hydraulic power for steering the wheels is provided by a third pump in the chassis, said third hydraulic pump being driven by the engine.

The third hydraulic pump may provide hydraulic power to a third valve arrangement in the chassis, and the hydraulic power for powering steering of the wheels may be controlled via the third valve arrangement in the chassis. The third valve arrangement may be separate to the first valve arrangement, but it is preferred that the third valve arrangement and the first valve arrangement form an integral part, and the third valve arrangement may be a part of the first valve arrangement.

It order to move the working boom between different positions during operation, it is preferred that the working boom is rotatably supported by the platform for rotation about a rotational axis parallel to an upper surface of the platform. It is also preferred that the working boom is rotatably supported by or mounted to the platform for rotating about a rotational axis normal to an upper surface of the platform. The hydraulic power for powering the rotation of the working boom may be controlled via the second valve arrangement in the rotatable platform.

The present disclosure covers embodiments wherein one or more auxiliary hydraulic couplers are mounted in the chassis of the vehicle, where the auxiliary chassis couplers may be arranged or configured for providing hydraulic power from the hydraulic pump(s) via the first valve arrangement to auxiliary hydraulic driven tools coupled to the auxiliary hydraulic couplers.

The present disclosure also covers embodiments wherein one or more auxiliary hydraulic couplers are mounted in the platform of the vehicle, where the auxiliary hydraulic couplers may be arranged for providing hydraulic power from the hydraulic pump(s) via the second valve arrangement to auxiliary hydraulic driven tools coupled to auxiliary hydraulic couplers.

In order to provide control signals for the hydraulic valve control arrangements, the present disclosure covers embodiments wherein the vehicle comprises control circuitry being operably connected to the first, second and/or third valve arrangements, and wherein the one or more driver controls of the rotatable platform are provided with user interface components operably connected to the control circuitry. The user interface components may be configured for inputting operator instruction signals to the control circuitry, and the control circuitry may be configured for controlling operation of the first, second and/or third valve arrangements and thereby controlling hydraulic power consumers connected to the first, second or third valve arrangements based on received operator instruction signals. It is preferred that the control circuitry is arranged in the platform, and that the swivel provides electric signal connections between signal cables from the control circuitry in the platform to signal cables to the first and/or third valve arrangement in the chassis.

It is within embodiments of the present disclosure, that the first valve arrangement of the chassis is provided with proportional valves for controlling at least part of the hydraulic power consumers connected to the chassis. Here, the proportional valves of the first valve arrangement of the chassis may be operably connected to the control circuitry for being controlled by a first number of control signals received from said control circuitry. It is also within embodiments of the present disclosure that the second valve arrangement of the rotatable platform is provided with proportional valves for controlling at least part of the hydraulic power consumers connected to the rotatable platform. Also here, the proportional valves of the second valve arrangement of the rotatable platform may be operably connected to the control circuitry for being controlled by a second number of control signals received from said control circuitry.

In order to start the engine of the vehicle, the engine may drive an electric power generator for charging a battery, where the battery may be arranged in the chassis, and the swivel may provide electric connections between power cables from the battery and/or electric power generator to power cables to the control circuitry in the platform.

For embodiments of the disclosure where the workstation is a multipurpose workstation, the workstation may be configured for carrying a tool selected from a list including: a dump body, a concrete mixer, and a body for holding logs. For embodiments of the disclosure where the working boom is a multipurpose working boom, the working boom may be configured for carrying a tool selected from a list including: a load bucket, an excavator bucket, an auger unit, a hedge trimmer, a crane claw, and a claw for holding logs. For embodiments of the disclosure having front and/or back couplings at the chassis, the couplings at the front of the chassis may be configured for carrying a blade, a sweeper, or a lawn mower, while the couplings at the back of the chassis may be configured for carrying a harrow, a plough or a load wagon.

The foregoing and other objects are achieved by the features of the independent claim. Further implementation forms are apparent from the dependent claims, the description and the figures.

These and other aspects of the invention will be apparent from and the embodiment(s) described below.

### BRIEF DESCRIPTION OF THE DRAWINGS

In the following detailed portion of the present disclosure, the invention will be explained in more detail with reference to the example embodiments shown in the drawings, in which:

FIG. 1 is an elevated view of a vehicle according to an embodiment of the disclosure;

FIG. 2 is a block diagram illustrating elements for controlling and driving the operation of the vehicle of FIG. 1 and tools coupled to the vehicle according to an embodiment of the disclosure;

FIG. 3 is a block diagram illustrating the arrangement of part of the control and driving elements in the chassis and the platform of the vehicle of FIG. 1 according to an embodiment of the disclosure;

FIG. 4 is an exploded view of the chassis and elements of the chassis of the vehicle of FIG. 1 according to an embodiment of the disclosure;

FIGS. 5a-5c illustrate the platform of the vehicle of FIG. 1 and part of the control and drive elements mounted to the platform according to an embodiment of the disclosure;

FIG. 6 is an elevated view of a vehicle carrying a concrete mixer at the chassis and having elements for coupling a tool to the back end of the chassis according to an embodiment of the disclosure;

FIG. 7 is an elevated view of a vehicle with a working boom coupled to the platform and carrying a claw for holding lodges according to an embodiment of the disclosure;

FIG. 8 is an elevated view of a vehicle with a working boom coupled to the platform and carrying an excavator bucket according to an embodiment of the disclosure;

FIG. 9 is an elevated view of a vehicle with a harrow coupled the back end of the chassis according to an embodiment of the disclosure;

FIG. 10 is an elevated view of a vehicle with a working boom coupled to the platform and carrying a hedge trimmer according to an embodiment of the disclosure;

FIG. 11 is an elevated view of a vehicle with a sweeper coupled to the front end of the chassis according to an embodiment of the disclosure;

FIG. 12 is an elevated view of a vehicle with a lawn mower coupled to the front end of the chassis according to an embodiment of the disclosure; and

FIG. 13 is an elevated view of a compact vehicle without a working boom according to an embodiment of the disclosure.

### DETAILED DESCRIPTION

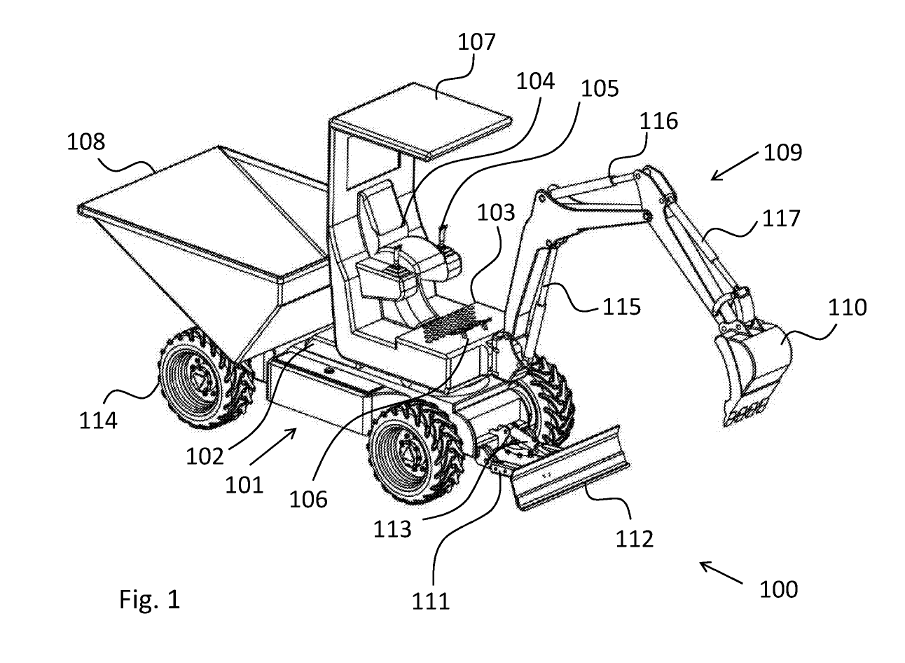

FIG. 1 shows a vehicle or multipurpose vehicle 100 according to an example embodiment. The vehicle 100 basically includes a chassis 101, a plurality of wheels 114, and a platform 103. The platform is rotatably mounted to the chassis 101 and holds a cabin 107 with a driver seat 104 and controls 105, 106 for the driver. A working boom 109 is coupled to the platform 103, and a workstation for carrying a tool 108 is connected to the chassis at a position next to the rotatable platform 103. For the vehicle 100 of FIG. 1, the tool 108 coupled to workstation of the chassis 101 is a dump body. It is preferred that the workstation for carrying the tool 108 is a multipurpose workstation for carrying a selectable tool 108. Besides a dump body 108, other tools such as a concrete mixer or a body for holding logs may be coupled to the workstation of the chassis 101.

The chassis 101 may be approximately block-like in configuration with a hollow interior for housing and supporting the vehicle's motor or engine, one or more hydraulic pumps, and other elements (not shown in FIG. 1). A cover 102 may be coupled to chassis 101 for covering the motor or engine. The hydraulic pumps of the chassis 101 provide hydraulic power to one or more hydraulic actuators for driving the workstation with tool 108. The pumps of the chassis 101 also provide hydraulic power to the platform 103 for driving the working boom 109 with tool 110.

For the vehicle 100 of FIG. 1, the tool 110 coupled to working boom 109 of the platform 103 is a load bucket. It is preferred that the working boom 109 is a multipurpose working boom 109 for carrying a selectable tool 110. Besides a load bucket 110, other tools such an excavator bucket, an auger unit, a hedge trimmer, a crane claw, and a claw for holding logs may be coupled to the working boom 109 of the platform 103. Hydraulic actuators 115, 116, 117, which are driven by hydraulic power from the pumps of the chassis 101, are provided at the working boom 109 for operating the boom 109 and the boom tool 110.

It is within an embodiment that the multipurpose vehicle 101 also has front and/or back couplings arranged at the front and/or the back end of the chassis 101 for carrying a tool, where the front and/or back couplings may be provided with hydraulic power from the hydraulic pump(s) of the chassis. The vehicle 101 shown in FIG. 1 has front coupler elements 111 at the front of the chassis 101, which elements are carrying a tool 112, and a hydraulic actuator 113, which is driven by hydraulic power from the pumps of the chassis 101, is provided for operating the front tool 112. The front tool 112 shown in FIG. 1 is a blade, but the front coupler 111 can also be coupled to other front tools 112, such as a sweeper or a lawn mower. Examples of back tools, which can be coupled to back coupler elements at the back of the chassis, are a harrow, a plough and a load wagon.

The platform 103 with the driver seat 104 and the working boom 109 may be mounted to the chassis 101 for rotating between a first position and a second position about a rotational axis normal to an upper surface of the chassis 101, where the platform is rotated a half circle or 180° when rotated from the first to the second position. It is preferred that the platform 103 is mounted for rotating between the first and second positions in both a clockwise and an anti-clockwise direction about the rotational axis. The platform 103 may be mounted to the chassis 101 so that it can rotate a full circle of 360° in both a clockwise and an anti-clockwise direction about the rotational axis. Hydraulic power for rotating the platform 103 is provided by the hydraulic pump(s) of the chassis 101.

For the vehicle 100 of FIG. 1, the working boom 109 is rotatably mounted to the platform 103 for rotating about a rotational axis parallel to an upper surface of the platform 103, where the rotation is operated via the actuator 115. The working boom 109 may also be rotatably mounted to the platform 103 for rotating about a rotational axis normal to an upper surface of the platform, where the rotation about this axis is operated by a hydraulic actuator (not shown in FIG. 1) arranged in or at the platform 103.

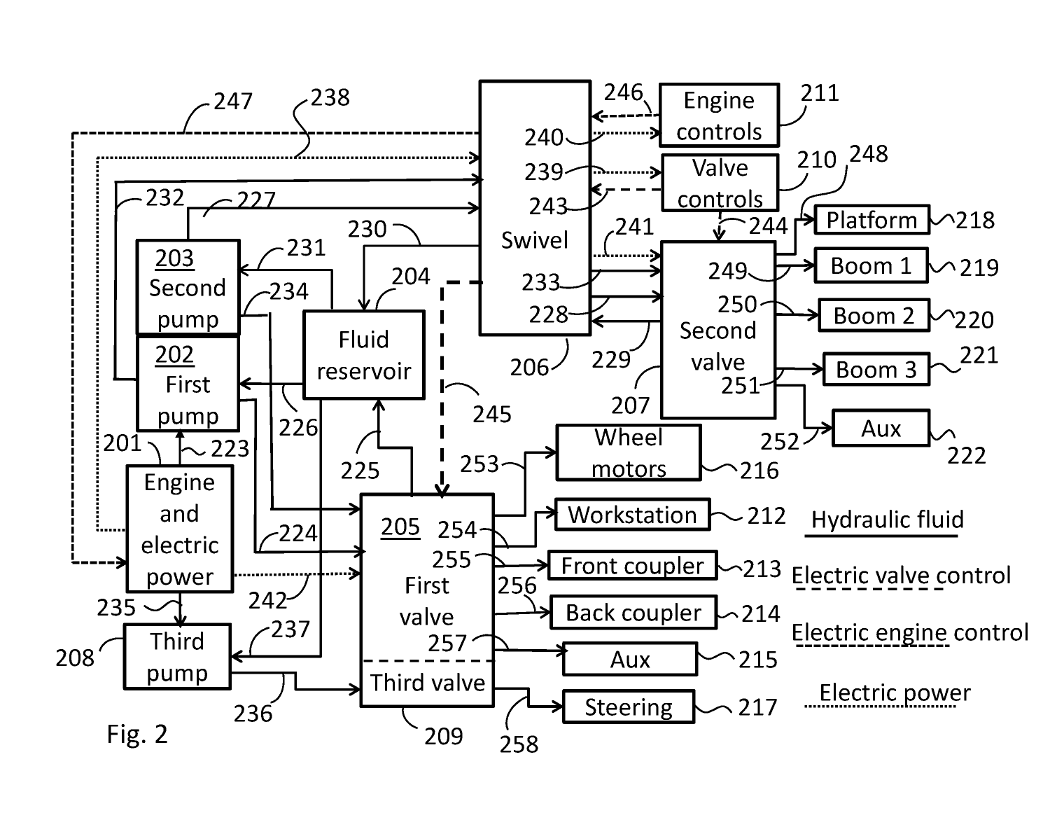

In order to control delivery of hydraulic power from the hydraulic pump(s) of the chassis 101, a number of control valves are arranged in the chassis 101 and the platform 103 and coupled between the pumps and the hydraulic actuators operating the tools 108, 110, 112. Control valves are also coupled between the pumps and hydraulic motors or actuators driving the wheels 114 and rotation of the platform 103. This is further illustrated in the block diagram of FIG. 2, as outlined below.

The block diagram of FIG. 2 shows an engine or motor 201 with an electric generator and a battery, which engine 201 is housed in the chassis 101. The engine 201 delivers power via coupling 223 to drive a first pump 202 and a second pump 203, both housed in the chassis 101. A first valve control arrangement 205 is also arranged in the chassis 101, where pressurized hydraulic fluid is provided to the first valve 205 from the first pump 202 via a hydraulic fluid supply conduit 224. The first valve 205 returns the hydraulic fluid to a fluid reservoir tank 204, which is also housed in the chassis 101, via a hydraulic fluid supply conduit 225. The reservoir 204 returns hydraulic fluid to the first pump 202 via a hydraulic fluid conduit 226.

A third pump 208, which is powered by the engine 201 via coupling 235, is also provided in the chassis 101, where the third pump 208 is arranged for providing pressurized hydraulic fluid to a third valve arrangement 209 via a hydraulic fluid conduit 236. The third valve 209 may be a separate valve arrangement being further connected to the fluid reservoir tank 204, but it is preferred that the third valve arrangement 209 is integrated with the first valve arrangement 205 and thereby in fluid connection with the reservoir 204. Hydraulic fluid is returned from the reservoir 204 to the third pump 208 via a hydraulic fluid conduit 237. In a preferred, but optional, embodiment of the disclosure, the second pump 203 also provides hydraulic fluid for driving the first valve 205 via a hydraulic fluid conduit 234. Hydraulic fluid is returned from the reservoir 204 to the second pump 203 via a hydraulic fluid conduit 231.

The first control valve arrangement 205 controls hydraulic power to hydraulic power consumers including hydraulic motors and actuators connected to or coupled to the chassis 101. The actuators may include: a workstation actuator 212 for operating the chassis workstation with tool 108, where the first valve arrangement 205 is in fluid connection with actuator 212 via a hydraulic fluid conduit 254; a front coupler actuator 213 for operating a front tool 112 (the actuator 213 corresponds to the actuator 113 of FIG. 1), where the first valve arrangement 205 is in fluid connection with actuator 213 via a hydraulic fluid conduit 255; and a back coupler actuator 214 for operating a tool coupled to the back end of the chassis 101, where the first valve arrangement 205 is in fluid connection with actuator 214 via a hydraulic fluid conduit 256. An auxiliary hydraulic power consumer 215 may also be connected to the chassis and supplied with hydraulic power from the first valve arrangement 205 via a hydraulic fluid conduit 257.

The wheels 114 may be driven by hydraulic wheel motors 216 arranged in the chassis, where the wheel motors 216 may also be supplied with hydraulic power from the first valve arrangement 205 via one or more hydraulic fluid conduits 253. Steering of the wheels may be operated by steering actuators 217 coupled to the wheels 114, where the steering actuators are supplied with hydraulic power from the third valve arrangement 209 via one or more hydraulic fluid conduits 258. It is noticed that the present disclosure also covers an embodiment where the third pump 208 is omitted and the third valve arrangement 209 receives hydraulic power from the first pump 202.

The block diagram of FIG. 2 also shows a swivel 206, which has a lower part arranged in the chassis 101 and an upper part arranged in the rotatable platform 103. The swivel is arranged for allowing hydraulic supply and return conduits to connect between the chassis 101 and the rotatable platform 103. A second control valve arrangement 207 is arranged in the platform 101, where hydraulic fluid is provided to the second valve 207 from the second pump 203 via a hydraulic fluid supply conduit 227, through the swivel 206, and via a hydraulic fluid supply conduit 228. The second valve 207 returns the hydraulic fluid to the fluid reservoir 204 in the chassis 101, via a hydraulic fluid return conduit 229, through the swivel 206, and via a hydraulic fluid return conduit 230. From the reservoir 204, fluid is returned to the second pump via return conduit 231. In a preferred, but optional, embodiment of the disclosure, the first pump 202 also provides hydraulic fluid for driving the second valve 207 via a hydraulic fluid conduit 232, through the swivel 206, and via a hydraulic fluid conduit 233.

The second control valve arrangement 207 controls hydraulic power to hydraulic power consumers, which may include hydraulic motors and actuators connected to or coupled to the platform 103. The actuators may include: first, second and third boom actuators 219, 220, 221 for operating the working boom 109 with tool 110 (here actuators 219, 220, 221 correspond to the actuators 115, 116, 117 of FIG. 1), where the second valve arrangement 207 is in fluid connection with actuators 219, 220, 221 via respective hydraulic fluid conduits 249, 250, 251. Further boom actuators being in fluid connection with the second valve arrangement 207 may be provided for operating the working boom 109, such as one or more actuators for operating rotation of the boom 109. An auxiliary hydraulic power consumer 222 may also be connected to the platform 103 and supplied with hydraulic power from the second valve arrangement 207 via a hydraulic fluid conduit 252.

Rotation of the platform 103 in relation to the chassis 101 may be driven by a hydraulic platform motor or actuator 218 arranged in the platform 103, where the platform motor/actuator 218 may also be supplied with hydraulic power from the second valve arrangement 207 via a hydraulic fluid conduit 248. In an alternative embodiment, the hydraulic motor/actuator 218 for rotating the platform 103 may be arranged in the chassis 101, where the platform motor/actuator 218 is supplied with hydraulic power via the first valve arrangement 205.

The swivel 206 is also configured for allowing electric signal cables and/or electric power cables to connect from the chassis 101 to the rotatable platform 103. A number of engine controls 211 are provided at the platform 103 for the driver to control the engine, where the engine controls 211 are supplied by electric power from the electric power part of the engine/electric power 201 via electric power cable(s) 238, through the swivel 206, and via electric power cable(s) 240. Control signals are supplied from the engine controls 211 to the engine/electric power 201 via signal cable(s) 246, through the swivel 206, and via signal cable(s) 247. A number of valve controls 210 are provided at the platform 103 for the driver to control the control the hydraulic power consumers via the control valve arrangements 207, 205. Electric power are supplied to the valve controls 210 by electric power from the electric power part of the engine/electric power 201 via the electric power cable(s) 238, through the swivel 206, and via electric power cable(s) 239. Control signals are supplied from the valve controls 210 to the second control valve arrangement 207 via signal cables 244, and to the first and third control valve arrangement via signal cables 243, through the swivel 206, and via signal cable(s) 245. Electric power need also to be supplied to the control valve systems 205, 209, 207, and electric power is supplied from the electric power part of the engine/electric power 201 to the first and third valve arrangements 205, 209 via electric power cable(s) 242, and to the second valve arrangement via the electric power cable(s) 238, through the swivel 206, and via electric power cable(s) 241.

The valve controls 210 receives inputs from the driver or operator via driver controls 105, 106, and the driver controls 105, 106 may be part of the valve controls 210. The driver controls 105, 106 and/or the valve controls 219 may include user interface components for receiving inputs from the driver or operator, and the user interface components are operably connected to electronic control circuitry, which control circuitry may be arranged in the platform and which may be configured for generating a number of electric control signals based on control actions of the driver or operator and received via the user interface components. The electronic control circuitry is operably connected to the first, second and or third valve arrangement 205, 207, 209, and the electronic control circuitry is configured for supplying a first number of control signals to the first and/or third valve arrangements 205, 209 for controlling at least part of the hydraulic power consumers connected to the chassis 101, and further coupled for supplying a second number of control signals to the second valve arrangement 207 for controlling at least part of the hydraulic power consumers connected to the rotatable platform 103.

In order to be controlled by the electronic control signals, the first valve arrangement 205 may be provided with proportional valves for controlling at least part of the hydraulic power consumers connected to the chassis 103, where the proportional valves of the first valve arrangement 205 are controlled by the first number of control signals. The third valve arrangement 209 may also be provided with proportional valves for controlling the steering actuators 217. The second valve arrangement 207 of the rotatable platform 103 may also be provided with proportional valves for controlling at least part of the hydraulic power consumers connected to the rotatable platform 103, where the proportional valves of the second valve arrangement 207 are controlled by the second number of control signals.

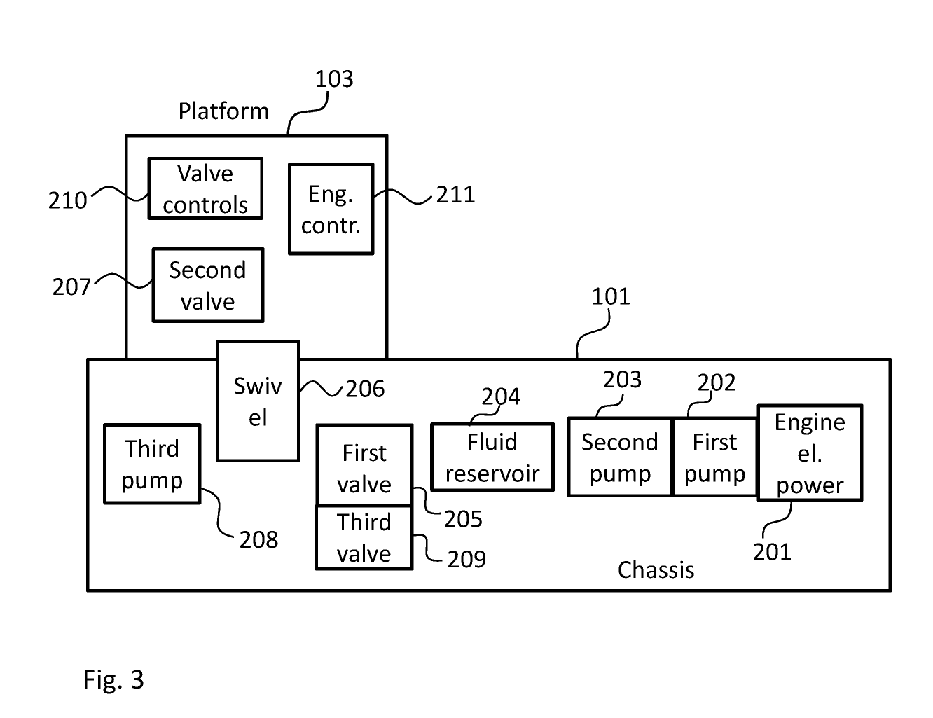

The block diagram of FIG. 3 illustrates the arrangement of part of the control and driving elements in the chassis 101 and the platform 103 of the vehicle of FIG. 1. In FIG. 3 the elements of the chassis 101 and the platform 103 are given the same reference numbers as in FIG. 2. The engine or motor together with the electric power generator and batteries, 201, are arranged in the chassis 101, which further holds the first, second, and third pumps, 202, 203, 208, being powered by the engine 201, and the fluid reservoir 204. The first and third control valve arrangements 205, 209 and a first lower part of the swivel 206 are also arranged in the chassis 101. A second upper part of the swivel 206 reaches into the rotatable platform 103, where the second upper part of the swivel 206 is rotatably connected to the first lower part of the swivel 206 in order to rotate with the platform 103. The platform also holds the second valve 207 and the engine and valve controls 211, 210.

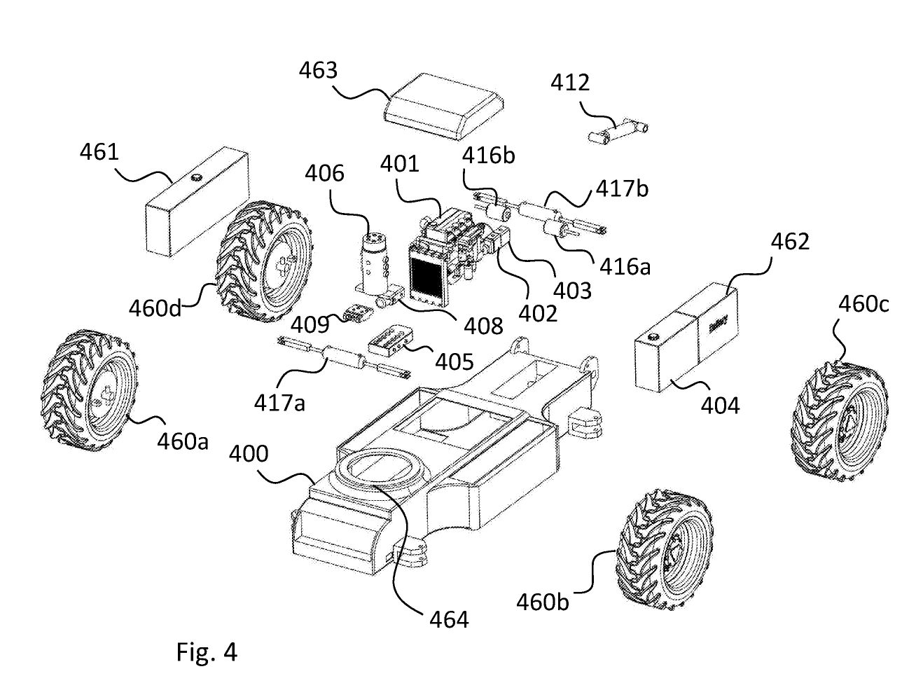

FIG. 4 is an exploded view of the chassis 101 and part of the elements within or coupled to the chassis of the vehicle 100 of FIG. 1. In FIG. 4, the chassis 400 is a block-like configuration with a hollow interior for housing and supporting the different elements, where the elements of the chassis 400 shown in FIG. 4 include (the reference numbers in parenthesis refer to the corresponding elements in FIG. 2): the vehicle's motor or engine 401 (201) for powering first and second hydraulic pumps 402, 403 (202, 203), which provide hydraulic power to the first valve arrangement 405 (205); the third pump 408 (208) providing hydraulic power to the third valve arrangement 409 (209), which again controls the hydraulic power delivered to the steering actuators 417a, 417b (217) being connected to the wheels 460a, 460b and 460c, 460d; rotation of the wheels 460a,b,c,d are driven by four hydraulic motors 416a, 416b (216), of which only two are shown in FIG. 4; the hydraulic fluid reservoir 404 (204) connecting the pumps and valves; the electric battery 462 (201) and a fuel tank 461 for delivering electric power and fuel to the engine 401 (201); the swivel 406 (206) for providing hydraulic fluid connections and electric signal connections between the elements of the chassis 400 and the elements of the platform. The elements supported by the chassis 400 also include different actuators being powered by the first valve arrangement 405 (205), where only the workstation actuator 412 (212) operating a tool on the workstation is shown in FIG. 4. A cover 463 for covering the engine 401 (201) and a platform connection part 464 are also shown in FIG. 4.

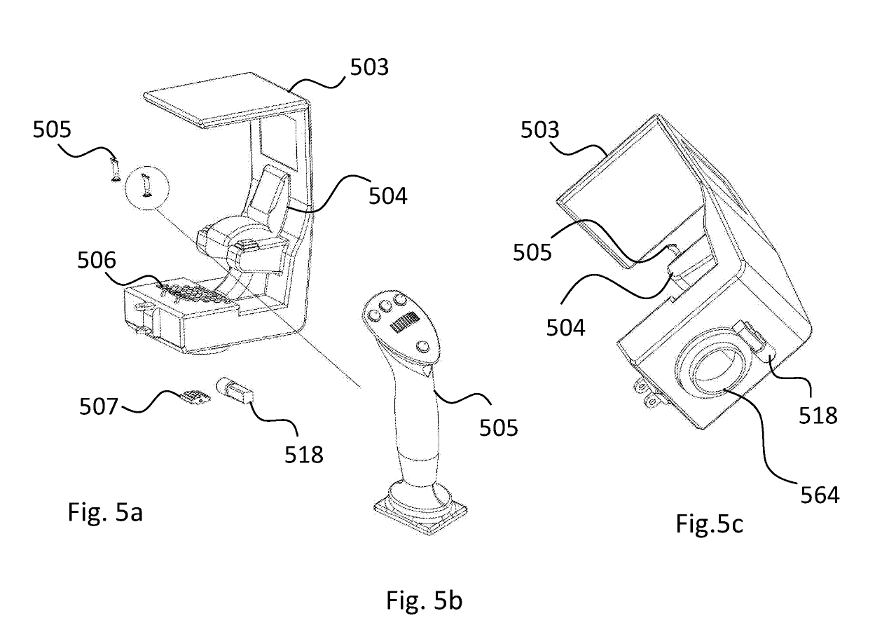

FIGS. 5a-5c illustrate the platform 103 of the vehicle 100 of FIG. 1 and part of the control and drive elements mounted to the platform 103. In FIGS. 5a-5c the platform 503 holds the driver seat 504 and the driver controls 505, 506, the second control valve arrangement 507 (207) and the hydraulic platform motor or actuator 518 (218). FIG. 5c is a bottom view of the platform showing a chassis connection part 564 and the arrangement of the platform motor/actuator 518 (218) (also here the reference numbers in the parenthesis refer to the corresponding elements in FIG. 2). The driver controls 505, 506 includes two joysticks 505, where FIG. 5b gives an enlarged view of such a joystick. Each joystick 505 includes a number of control buttons, such as four, which can be used to activate different proportional valves of the valve arrangements 405, 409, 507 (205, 209, 207), while the movement of the joystick 505 can be used to control the degree of opening and closing of the proportional valves and thereby the degree of fluid flow to and from the hydraulic actuators/motors connected to the proportional valves of the valve arrangements 405, 409, 507 (205, 209, 207). Here, the driving speed of the vehicle 100 may be controlled by the degree of opening and closing of the proportional valves of the first valve arrangement 405 (205) connected to the hydraulic wheel motors 416a, 416b (216), and the driving direction of the vehicle 100 may be controlled by the degree of opening and closing of the proportional valves of the third valve arrangement 409 (209) connected to the steering actuators 417a, 417b (217).

Alternatively, the driver control 506 may include a throttle or gas pedal for controlling the driving speed of the vehicle 100 by controlling the degree of opening and closing of the proportional valves of the first valve arrangement 405 (205) connected to the hydraulic wheel motors 416a, 416b (216).

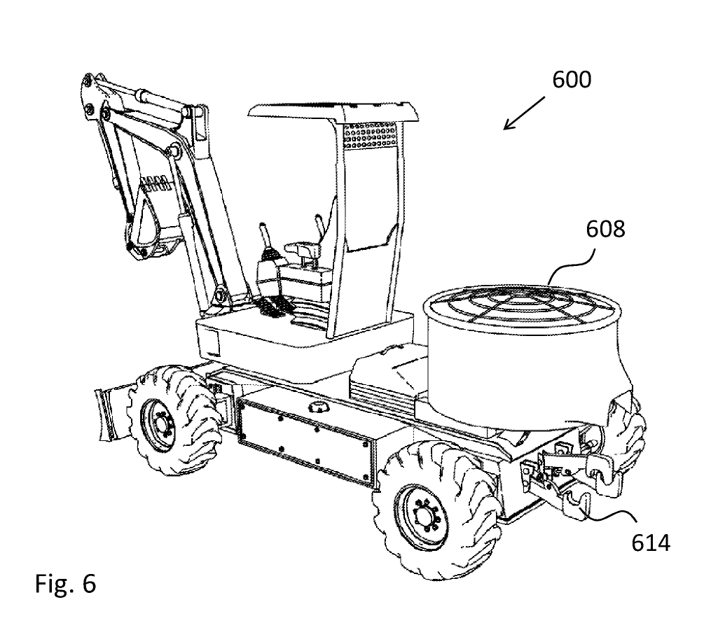

It has already been discussed that the present disclosure covers embodiments of a vehicle 100, which is a multipurpose vehicle, for which the working boom 109 coupled to the platform 103 is designed for carrying a number of selectable tools, and for which the workstation of the chassis 101 may also be designed for carrying different tools. Furthermore, the chassis 101 may have front and/or back couplers for carrying different tools. FIGS. 6-12 show embodiments of a multipurpose vehicle according to the present disclosure with different working tools.

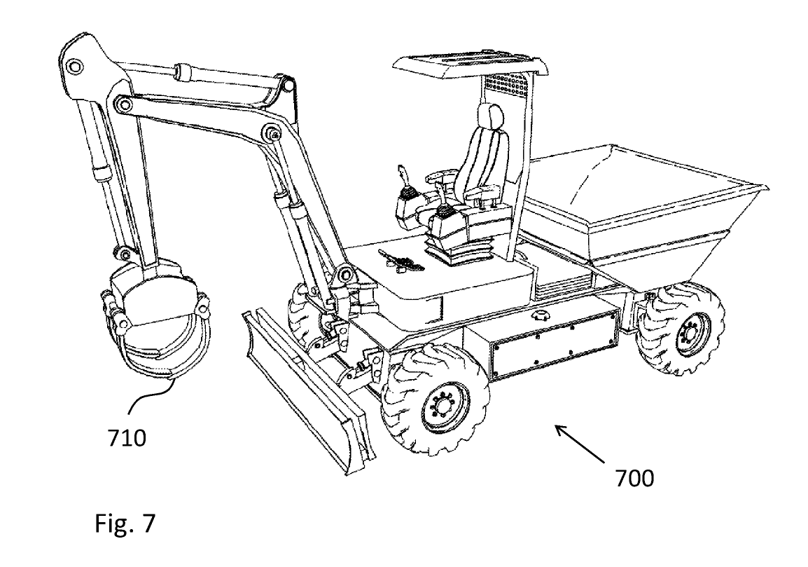

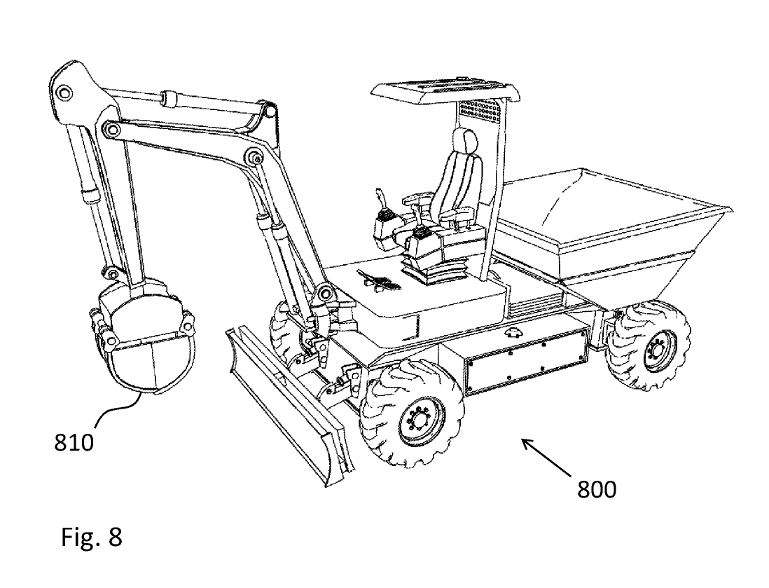

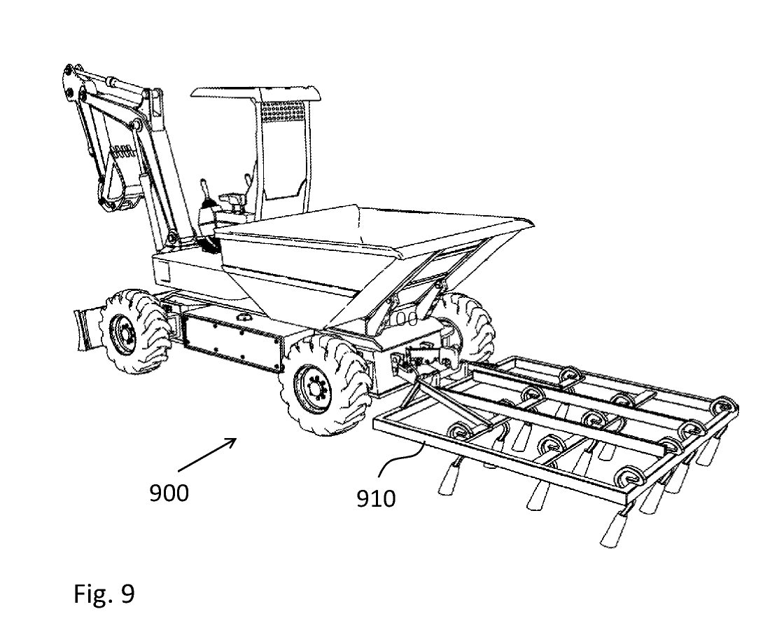

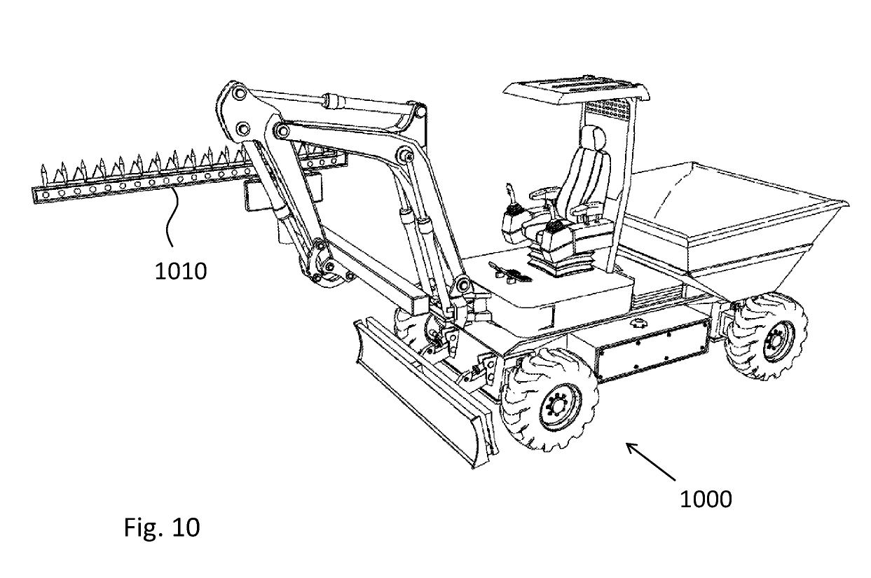

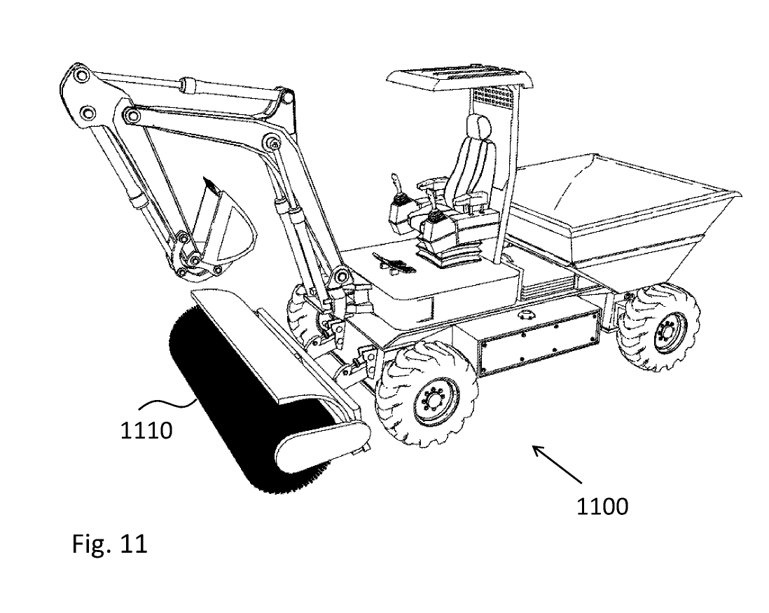

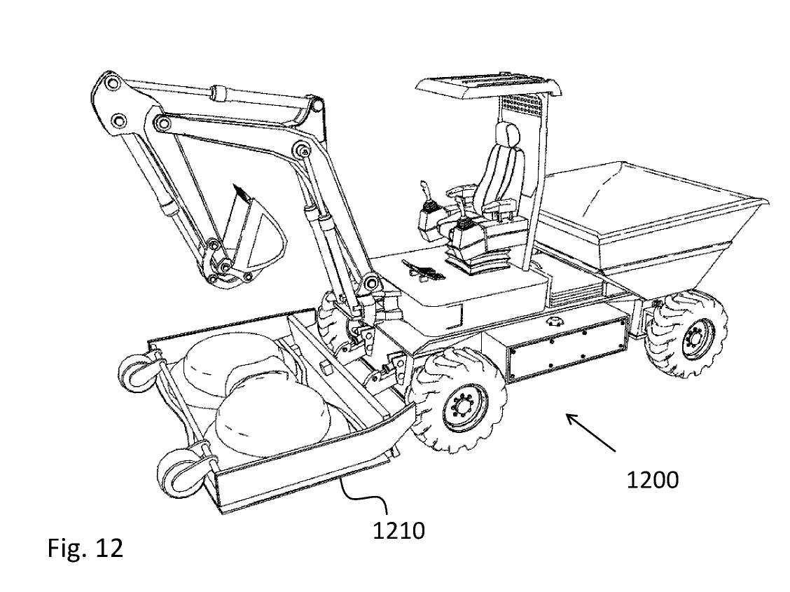

FIG. 6 shows a vehicle 600 carrying a concrete mixer 608 at the chassis and having elements 614 for coupling a tool to the back end of the chassis; FIG. 7 shows a vehicle 700 with a working boom coupled to the platform and carrying a claw 710 for holding lodges; FIG. 8 shows a vehicle 800 with a working boom coupled to the platform and carrying an excavator bucket 810; FIG. 9 shows a vehicle 900 with a harrow 910 coupled the back end of the chassis; FIG. 10 shows a vehicle with a working boom coupled to the platform and carrying a hedge trimmer 1010; FIG. 11 shows a vehicle with a sweeper 1110 coupled to the front end of the chassis; and FIG. 12 shows a vehicle 1200 with a lawn mower 1210 coupled to the front end of the chassis.

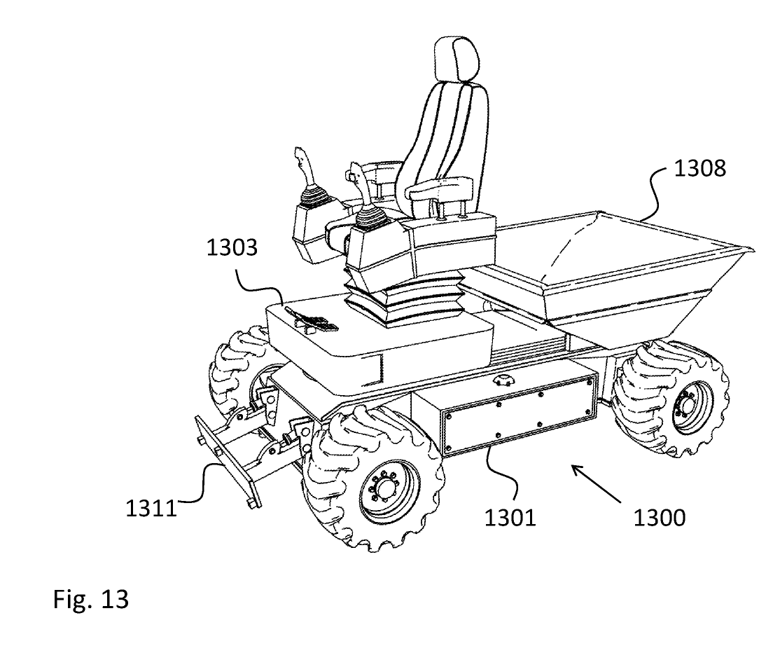

The present disclosure also covers a compact multipurpose vehicle 1300 as shown in FIG. 13. The vehicle 1300 is similar to the vehicle 100 shown in FIG. 1 with the exception that the vehicle 1300 has no working boom 109 with a tool 110 coupled to the platform 1303. In FIG. 13 there is no cabin on the platform 1303, but the vehicle 1300 may be provided with a cabin on the platform. The vehicle 1300 also has a front coupler element 1311 for carrying a tool, but in FIG. 13 no tool is yet connected to the front coupler element 1311. Also for the vehicle 1300 of FIG. 13 a workstation for carrying a tool 1308 is connected to the chassis 1301, with the tool 1308 being a dump body 1308. The workstation of the vehicle 1300 may be configured for use with the dump body 1308 only, but may also be configured for use other tools, such as the tools mentioned for the vehicle 100 of FIG. 1.

An important feature of the vehicle of the present disclosure is that the platform is provided with hydraulic power from hydraulic pumps in the chassis, while the platform is rotatably mounted to the chassis. In order to obtain a full rotation of the platform relative to the chassis, a swivel can be used for providing hydraulic fluid connections and electric signal connections between the platform and the chassis. The swivel may be a hydraulic swivel joint with integrated electrical slip ring or the swivel may be a combination of a separate electrical slip ring and a separate hydraulic swivel.

The invention has been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

1. A self-propelled multipurpose vehicle comprising:
a chassis including an engine driving one or more hydraulic pumps;
a rotatable platform with a driver seat and one or more controls for a driver,
said rotatable platform being rotatably supported by the chassis, and said rotatable platform being provided with hydraulic power from at least one of said one or more hydraulic pumps; and
a workstation for carrying a tool, said workstation being connected to the chassis at a position next to the rotatable platform, and said workstation being provided with hydraulic power from the hydraulic pump(s).

2. A multipurpose vehicle according to claim 1, wherein the chassis has an at least partly horizontal extending upper surface for supporting said platform and workstation next to one another.

3. A multipurpose vehicle according to claim 2, wherein the rotatable platform is mounted to the chassis for rotating about a rotational axis normal to a horizontal extending upper surface part of the chassis.

4. A multipurpose vehicle according to any one of the claims 1 to 3, wherein the workstation for carrying a tool is a multipurpose workstation for carrying a tool selected from a plurality of different tools.

5. A multipurpose vehicle according to any one of the claims 1 to 4, further comprising a working boom for carrying a tool, said working boom being supported by the rotatable platform and powered by hydraulic power from the hydraulic pump(s).

6. A multipurpose vehicle according to claim 5, wherein the working boom for carrying a tool is a multipurpose boom for carrying a tool selected from a plurality of different tools.

7. A multipurpose vehicle according to any one of the claims 1 to 6, further comprising hydraulic couplings arranged at the front and/or the back end of the chassis for carrying a tool, said front and/or back couplings being provided with hydraulic power from the hydraulic pump(s).

8. A multipurpose vehicle according to any one of the claims 1 to 7, further comprising
a first valve arrangement in the chassis for controlling hydraulic power from the hydraulic pump(s) to hydraulic power consumers connected to the chassis.

9. A multipurpose vehicle according to any one of the claims 1 to 8, further comprising
a second valve arrangement arranged in the rotatable platform for controlling hydraulic power from the hydraulic pump(s) to hydraulic power consumers connected to the rotatable platform.

10. A multipurpose vehicle according to claims 8 and 9, wherein the chassis includes at least a first and a second hydraulic pump being driven by the engine, said first hydraulic pump being arranged for providing hydraulic power to at least part of the valves of the first valve arrangement, and said second hydraulic pump being arranged for providing hydraulic power to at least part of the valves of the second valve arrangement.

11. A multipurpose vehicle according to claim 10, wherein said first hydraulic pump is arranged for providing hydraulic power to at least part of the valves of the second valve arrangement, and said second hydraulic pump is arranged for providing hydraulic power to at least part of the valves of the first valve arrangement.

12. A multipurpose vehicle according to any one of the claims 8 to 11, wherein the chassis further includes at least one hydraulic fluid reservoir for supplying hydraulic fluid to the hydraulic pump(s) and for receiving a return of hydraulic fluid from the valve arrangements.

13. A multipurpose vehicle according to any one of the claims 1 to 12, further comprising a swivel or swivel joint between the chassis and the rotatable platform for allowing hydraulic supply and return conduits to connect between the chassis and the rotatable platform.

14. A multipurpose vehicle according to claim 13, wherein the swivel is further configured for allowing electric signal cables and/or electric power cables to connect between the chassis and the rotatable platform.

15. A multipurpose vehicle according to claim 10 or 11, claim 12, and claim 13 or 14, wherein the swivel provides a hydraulic supply connection between a supply conduit in the chassis from the second pump and a supply conduit in the platform to the second valve arrangement, and further provides a hydraulic return connection between a return conduit in the platform from the second valve arrangement and a return conduit in the chassis to the hydraulic fluid reservoir.

16. A multipurpose vehicle according to claim 15, wherein the swivel further provides a hydraulic supply connection between a supply conduit in the chassis from the first pump and a supply conduit in the platform to the second valve arrangement.

17. A multipurpose vehicle according to any one of the claims 8 to 16, wherein the hydraulic power for powering said workstation is controlled via the first valve arrangement in the chassis.

18. A multipurpose vehicle according to claim 5 or 6 and any one of the claims 9 to 17, wherein the hydraulic power for powering said working boom is controlled via the second valve arrangement in the rotatable platform.

19. A multipurpose vehicle according to claims 7 and any one of the claims 8 to 18, wherein the hydraulic power for powering said hydraulic front and/or back couplings is controlled via the first valve arrangement in the chassis.

20. A multipurpose vehicle according to any one of the claims 1 to 19, wherein the rotatable platform is mounted to the chassis for rotating between a first position and a second position about a rotational axis normal to an upper surface of the chassis, said rotatable platform being rotated a half circle or 180° when rotated from the first to the second position.

21. A multipurpose vehicle according to claim 20, wherein the platform is mounted for rotating between the first and second positions in both a clockwise and an anti-clockwise direction about the rotational axis.

22. A multipurpose vehicle according to claim 20 or 21, wherein the platform is mounted for being rotating a full circle of 360° in both a clockwise and an anti-clockwise direction about the rotational axis.

23. A multipurpose vehicle according to any one of the claims 1 to 22, wherein rotation of the platform is powered by hydraulic power from the hydraulic pump(s).

24. A multipurpose vehicle according to claims 9 and 23, wherein the hydraulic power for powering the rotation of the platform is controlled via the second valve arrangement in the rotatable platform.

25. A multipurpose vehicle according to claims 8 and 23, wherein the hydraulic power for powering the rotation of the platform is controlled via the first valve arrangement in the chassis.

26. A multipurpose vehicle according to any one of the claims 10 to 25, wherein the chassis is further provided with a plurality of linear hydraulic actuators powered by hydraulic fluid from said first or second or a third pump in said chassis via a valve arrangement in said chassis.

27. A multipurpose vehicle according to any one of the claims to 26, wherein the chassis is provided with four hydraulically driven and hydraulically steerable wheels.

28. A multipurpose vehicle according to claim 27, wherein said wheels are each provided with a hydraulic wheel motor that is supplied with hydraulic fluid from said first or second or a third pump in said chassis via a valve arrangement in said chassis.

29. A multipurpose vehicle according to claim 27 or 28, wherein hydraulic power for steering said wheels is provided by said first or second or a third pump in said chassis via a valve arrangement in said chassis.

30. A multipurpose vehicle according to claim 27 or 28, wherein hydraulic power for steering said wheels is provided by a third pump in said chassis, said third hydraulic pump being driven by the engine.

31. A multipurpose vehicle according to claim 30, wherein the third hydraulic pump provides hydraulic power to a third valve arrangement in the chassis, and wherein the hydraulic power for powering steering of the wheels is controlled via the third valve arrangement in the chassis.

32. A multipurpose vehicle according to claims 8 and 31, wherein the third valve arrangement and the first valve arrangement form an integral part.

33. A multipurpose vehicle according to any one of the claims 27 to 32, wherein the hydraulic power for powering rotation of the wheels is controlled via the first valve arrangement in the chassis.

34. A multipurpose vehicle according to any one of the claims 5 to 33, wherein the working boom is rotatably supported by the platform for rotation about a rotational axis parallel to an upper surface of the platform.

35. A multipurpose vehicle according to any one of the claims 5 to 34, wherein the working boom is rotatably mounted to the platform for rotating about a rotational axis traverse to an upper surface of the platform.

36. A multipurpose vehicle according to claim 9 and 34 or 35, wherein the hydraulic power for powering the rotation of the working boom is controlled via the second valve arrangement in the rotatable platform.

37. A multipurpose vehicle according to any one of the claims 8 to 36, further comprising one or more auxiliary hydraulic couplers mounted in the chassis, said auxiliary hydraulic couplers being arranged for providing hydraulic power from the hydraulic pump(s) via the first valve arrangement to auxiliary hydraulic driven tools coupled to said auxiliary hydraulic couplers.

38. A multipurpose vehicle according to any one of the claims 9 to 37, further comprising one or more auxiliary hydraulic couplers mounted in the platform, said auxiliary hydraulic couplers being arranged for providing hydraulic power from the hydraulic pump(s) via the second valve arrangement to auxiliary hydraulic driven tools coupled to said auxiliary hydraulic couplers.

39. A multipurpose vehicle according to any one of the claims 8 to 38, further comprising control circuitry being operably connected to said first, second and/or third valve arrangements, and wherein the one or more driver controls of the rotatable platform are provided with user interface components operably connected to the control circuitry.

40. A multipurpose vehicle according to claim 39, wherein the user interface components are configured for inputting operator instruction signals to the control circuitry, and wherein the control circuitry is configured for controlling operation of said first, second and/or third valve arrangements and thereby controlling hydraulic power consumers connected to said first, second or third valve arrangements based on received operator instruction signals.

41. A multipurpose vehicle according to claim 14 and 39 or 40, wherein the control circuitry is arranged in the platform, and wherein the swivel provides electric signal connections between signal cables from the control circuitry in the platform to signal cables to the first and/or third valve arrangement in the chassis.

42. A multipurpose vehicle according to any one of the claims 8 to 41, wherein the first valve arrangement of the chassis is provided with proportional valves for controlling at least part of the hydraulic power consumers connected to the chassis.

43. A multipurpose vehicle according to claims 39 and 42, wherein the proportional valves of the first valve arrangement of the chassis are operably connected to the control circuitry for being controlled by a first number of control signals received from said control circuitry.

44. A multipurpose vehicle according to any one of the claims 9 to 43, wherein the second valve arrangement of the rotatable platform is provided with proportional valves for controlling at least part of the hydraulic power consumers connected to the rotatable platform.

45. A multipurpose vehicle according to claims 39 and 44, wherein the proportional valves of the second valve arrangement of the rotatable platform are operably connected to the control circuitry for being controlled by a second number of control signals received from said control circuitry.

46. A multipurpose vehicle according to any one of the claims 14 to 45, wherein the engine in the chassis drives an electric power generator for charging a battery, and wherein the swivel provides electric connections between power cables from the battery/electric power generator of the engine to power cables to the control circuitry in the platform.

47. A multipurpose vehicle according to any one of the claims 1 to 46, wherein the workstation is configured for carrying a tool selected from a list including: a dump body, a concrete mixer, a body for holding logs.

48. A multipurpose vehicle according to any one of the claims 5 to 47, wherein the working boom is configured for carrying a tool selected from a list including: a load bucket, an excavator bucket, an auger unit, a hedge trimmer, a crane claw, a claw for holding logs.

49. A multipurpose vehicle according to any one of the claims 7 to 48, wherein the front couplings at the front of the chassis is configured for carrying a blade, a sweeper, or a lawn mower.

50. A multipurpose vehicle according to any one of the claims 7 to 49, wherein the back couplings at the back of the chassis is configured for carrying a harrow or a plough.

51. A self-propelled multipurpose vehicle comprising:
a chassis including an engine or motor driving one or more hydraulic pumps;
a rotatable platform with a driver seat and one or more controls for a driver,
said rotatable platform being rotatably supported by the chassis, and said rotatable platform being provided with hydraulic power from at least one of said one or more hydraulic pumps;
a workstation for carrying a tool, said workstation being connected to the chassis at a position next to the rotatable platform, and said workstation being provided with hydraulic power from the hydraulic pump(s); and
a swivel or swivel joint between the chassis and the rotatable platform for allowing hydraulic supply and return conduits to connect between the chassis and the rotatable platform.
